(19) United States
(12) Patent Application Publication
(10) Pub. No.: US 2025/0217675 A1
(43) Pub. Date: Jul. 3, 2025

(54) METHOD, DEVICE, AND APPARATUS WITH TENSOR BROADCASTING OPERATION

(71) Applicant: SAMSUNG ELECTRONICS CO., LTD., Suwon-si (KR)

(72) Inventors: Zhenxin YANG, Xi'an (CN); Fei CHEN, Xi'an (CN); Sung-Jae CHO, Suwon-si (KR); Yanpeng WANG, Xi'an (CN); Byung In YOO, Suwon-si (KR); Changyong SON, Suwon-si (KR); Jonghoon YOON, Suwon-si (KR); Yunhao ZHANG, Xi'an (CN); Ying MIN, Xi'an (CN)

(73) Assignee: SAMSUNG ELECTRONICS CO., LTD., Suwon-si (KR)

(21) Appl. No.: 18/981,989

(22) Filed: Dec. 16, 2024

(30) Foreign Application Priority Data
Dec. 27, 2023 (CN) 202311827441.4
Aug. 26, 2024 (KR) 10-2024-0114560

(51) Int. Cl. G06N 5/04

(52) U.S. Cl. CPC G06N 5/04

(57) ABSTRACT

A processor-implemented method including, based on a first shape of a first tensor and a second shape of a second tensor used in an operation with the first tensor, determining a broadcasting type related to an extension of the first shape and the second shape, determining respective first shape offsets for each dimension of the first shape and respective second shape offsets for each dimension of the second shape based on the broadcasting type, determining respective first tensor offsets for each dimension of the first tensor and respective second tensor offsets for each dimension of the second tensor based on the broadcasting type, the respective first shape offsets for each dimension of the first shape, and the respective second shape offsets for each dimension of the second shape, determining a first offset of a first element included in the first tensor and a second offset of a second element included in the second tensor based on the respective first tensor offsets and the respective second tensor offsets, and performing the operation by obtaining the first element and the second element based on the first offset and the second offset.

### CROSS-REFERENCE TO RELATED APPLICATIONS

This application claims the benefit under 35 USC § 119 (a) of Chinese Patent Application No. 202311827441.4 filed on Dec. 27, 2023, in the China National Intellectual Property Administration, and Korean Patent Application No. 10-2024-0114560 filed on Aug. 26, 2024, in the Korean Intellectual Property Office, the entire disclosures of which are incorporated herein by reference for all purposes.

### BACKGROUND

### 1. Field

The following description relates to an electronic device, method, and apparatus with a broadcasting tensor operation.

### 2. Description of Related Art

When deploying an artificial intelligence model to a hardware device, various inference engines may generally be used. The inference engine may include an operator library that may implement many operators. The operator library may include broadcasting operators (or broadcasting computing). In order to perform an operation on a first tensor and a second tensor, dimension sizes of corresponding dimensions between the tensors may need to match. Broadcasting computing may be an operation of extending a first dimension size of the first tensor to match a second dimension size of the corresponding dimension of the second tensor when the first tensor includes, for example, a dimension having a dimension size of 1 and the dimension size of the corresponding dimension of the second tensor is different from 1.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including, based on a first shape of a first tensor and a second shape of a second tensor used in an operation with the first tensor, determining a broadcasting type related to an extension of the first shape and the second shape, determining respective first shape offsets for each dimension of the first shape and respective second shape offsets for each dimension of the second shape based on the broadcasting type, determining respective first tensor offsets for each dimension of the first tensor and respective second tensor offsets for each dimension of the second tensor based on the broadcasting type, the respective first shape offsets for each dimension of the first shape, and the respective second shape offsets for each dimension of the second shape, determining a first offset of a first element included in the first tensor and a second offset of a second element included in the second tensor based on the respective first tensor offsets and the respective second tensor offsets, and performing the operation by obtaining the first element and the second element based on the first offset and the second offset.

The determining of the respective first tensor offsets and the respective second tensor offsets may include determining first respective cumulative tensor offsets for each dimension of the first tensor and second respective cumulative tensor offsets for each dimension of the second tensor based on the respective first tensor offsets and the respective second tensor offsets and determining the first offset and the second offset based on a sum of the first respective cumulative tensor offsets first offset and the second respective cumulative tensor offsets.

The determining the first respective cumulative tensor offsets and the respective second tensor offsets may include determining an N-th variable as a current variable and an N-th dimension as a current dimension and determining whether the current variable is smaller than a larger dimension size among a dimension size of the current dimension of the first tensor and a dimension size of the current dimension of the second tensor, and the N is a natural number less than or equal to M, a total number of dimensions of the first tensor and the second tensor, and greater than or equal to 1.

The determining the first respective cumulative tensor offsets and the respective second tensor offsets may also include in response to the N being greater than or equal to 1 and less than M, and the current variable being smaller than a larger dimension size among the dimension size of the current dimension of the first tensor and the dimension size of the current dimension of the second tensor, updating the N-th variable by adding 1 to the N-th variable, determining a cumulative offset of a (N+1)-th dimension of the first tensor as a first specific value, determining a cumulative offset of a (N+1)-th dimension of the second tensor as the first specific value, and determining a (N+1)-th variable as a first predetermined value and performing the determining of whether the current variable is smaller than a larger dimension size among the dimension size of the current dimension of the first tensor and the dimension size of the current dimension of the second tensor by updating the (N+1)-th variable to the current variable and updating the (N+1)-th dimension to the current dimension.

The determining the first respective cumulative tensor offsets and the respective second tensor offsets may include, in response to the N being equal to M, and the current variable being smaller than a larger dimension size among the dimension size of the current dimension of the first tensor and the dimension size of the current dimension of the second tensor, updating the N-th variable by adding 1 to the N-th variable, determining the first offset based on the sum of the first respective cumulative tensor offsets, and determining the second offset based on the sum of the second respective cumulative tensor offsets.

The determining the first respective cumulative tensor offsets first offset and the respective second tensor offsets may also include, in response to the N being greater than 1 and less than or equal to M, and the current variable being greater than or equal to a larger dimension size among the dimension size of the current dimension of the first tensor and the dimension size of the current dimension of the second tensor, updating a cumulative offset corresponding to a (N−1)-th dimension of the first tensor by adding an offset corresponding to the (N−1)-th dimension of the first tensor to the cumulative offset corresponding to the (N−1)-th dimension of the first tensor, and updating a cumulative offset corresponding to a (N−1)-th dimension of the second tensor by adding an offset corresponding to the (N−1)-th dimension of the second tensor to the cumulative offset corresponding to the (N−1)-th dimension of the second tensor and performing the determining of whether the current variable is smaller than a larger dimension size by updating the (N−1)-th variable to the current variable and updating the (N−1)-th dimension to the current dimension.

The determining the respective first tensor offsets and the respective second tensor offsets may also include, in response to a value of an N-th dimension of the broadcasting type being a first value, determining an offset corresponding to the N-th dimension of the first tensor as an offset corresponding to the N-th dimension of the first shape, and determining an offset corresponding to the N-th dimension of the second tensor as an offset corresponding to the N-th dimension of the second shape, in response to the value of the N-th dimension of the broadcasting type being a second value, determining the offset corresponding to the N-th dimension of the first tensor as a second specific value, and determining the offset corresponding to the N-th dimension of the second tensor as the offset corresponding to the N-th dimension of the second shape, and, in response to the value of the N-th dimension of the broadcasting type being a third value, determining the offset corresponding to the N-th dimension of the first tensor as the offset corresponding to the N-th dimension of the first shape, and determining the offset corresponding to the N-th dimension of the second tensor as the second specific value, and that the Nis a natural number less than or equal to M, a total number of dimensions of the first tensor and the second tensor, and greater than or equal to 1.

The determining of the respective first shape offsets and the respective second shape offsets may include determining a first offset of each dimension except a rightmost dimension of the first shape based on at least one next dimension, and determining a third offset of the rightmost dimension of the first shape as a third specific value and determining a second offset of each dimension except a rightmost dimension of the second shape based on the at least one next dimension, and determining a fourth offset of the rightmost dimension of the second shape as the third specific value.

The determining of the broadcasting type may include, in response to the first shape and the second shape having a same dimension size in an N-th dimension, determining a dimension value of the N-th dimension of the broadcasting type as a first value, in response to the first shape and the second shape having different dimension sizes in the N-th dimension and the first shape having 1 in the N-th dimension, determining the dimension value of the N-th dimension of the broadcasting type as a second value, and, in response to the first shape and the second shape having different dimension sizes in the N-th dimension and the second shape having 1 in the N-th dimension, determining the dimension value of the N-th dimension of the broadcasting type as a third value, and that the N is a natural number less than or equal to M, a total number of dimensions of the first tensor and the second tensor, and greater than or equal to 1.

The method may include, in response to the first shape of the first tensor and the second shape of the second tensor having a dimension size in at least two corresponding consecutive dimensions, determining the first shape and the second shape by merging the at least two consecutive dimensions.

In a general aspect, here is provided a non-transitory computer-readable storage medium storing instructions that, when executed by a processor, cause the processor to perform the method.

In a general aspect, here is provided a processor-implemented method including, based on a first shape of a first tensor and a second shape of a second tensor used in an operation with the first tensor, determining a broadcasting type related to an extension of the first shape and the second shape and performing an operation of the first tensor and the second tensor by executing a pre-generated program based on the broadcasting type, the performing of the operation of the first tensor and the second tensor by executing the pre-generated program including determining respective first shape offsets for each dimension of the first shape and respective second shape offsets for each dimension of the second shape, determining respective first tensor offsets for each dimension of the first tensor and respective second tensor offsets for each dimension of the second tensor based on the broadcasting type, the respective first shape offsets, and the respective second shape offsets, determining a first offset of a first element included in the first tensor and a second offset of a second element included in the second tensor based on the respective first tensor offsets and the respective second tensor offsets, and performing the operation by obtaining the first element and the second element based on the first offset and the second offset.

In a general aspect, here is provided an electronic device including one or more processors configured to execute instructions and a memory storing the instructions, and an execution of the instructions configures the one or more processors to, based on a first shape of a first tensor and a second shape of a second tensor used in an operation with the first tensor, determine a broadcasting type related to an extension of the first shape and the second shape, determine respective first shape offsets for each dimension of the first shape and respective second shape offsets for each dimension of the second shape based on the broadcasting type, determine respective first tensor offsets for each dimension of the first tensor and respective second tensor offsets for each dimension of the second tensor based on the broadcasting type, the respective first shape offsets, and the respective second shape offsets, determine a first offset of a first element included in the first tensor and a second offset of a second element included in the second tensor based on the respective first tensor offsets and the respective second tensor offsets, and perform the operation by obtaining the first element and the second element based on the first offset and the second offset.

The one or more processors may be further configured to determine first respective cumulative tensor offsets for each dimension of the first tensor and second respective cumulative tensor offsets for each dimension of the second tensor based on the respective first tensor offsets and the respective second tensor offsets and determine the first offset and the second offset based on a sum of the first respective cumulative tensor offsets and a sum of the second respective cumulative tensor offsets.

The one or more processors may be further configured to determine an N-th variable as a current variable and an N-th dimension as a current dimension and determine whether the current variable is smaller than a larger dimension size among a dimension size of the current dimension of the first tensor and a dimension size of the current dimension of the second tensor, and that the N is a natural number less than or equal to M, a total number of dimensions of the first tensor and the second tensor, and greater than or equal to 1.

The one or more processors may be further configured to, in response to the N being greater than or equal to 1 and less than M, and the current variable being smaller than a larger dimension size among the dimension size of the current dimension of the first tensor and the dimension size of the current dimension of the second tensor, update the N-th variable by adding 1 to the N-th variable, determine a cumulative offset of a (N+1)-th dimension of the first tensor as a first specific value, determine a cumulative offset of a (N+1)-th dimension of the second tensor as a first specific value, and determine a (N+1)-th variable as a first predetermined value and perform the determination of whether the current variable is smaller than a larger dimension size among the dimension size of the current dimension of the first tensor and the dimension size of the current dimension of the second tensor by updating the (N+1)-th variable to the current variable and updating the (N+1)-th dimension to the current dimension.

The one or more processors may be further configured to, in response to the N being equal to M, and the current variable being smaller than a larger dimension size among the dimension size of the current dimension of the first tensor and the dimension size of the current dimension of the second tensor, update the N-th variable by adding 1 to the N-th variable, determine the first offset based on the sum of the first respective cumulative tensor offsets, and determine the second offset based on the sum of the second respective cumulative tensor offsets.

The one or more processors may be further configured to, in response to the N being greater than 1 and less than or equal to M, and the current variable being greater than or equal to a larger dimension size among the dimension size of the current dimension of the first tensor and the dimension size of the current dimension of the second tensor, update a cumulative offset corresponding to a (N−1)-th dimension of the first tensor by adding an offset corresponding to the (N−1)-th dimension of the first tensor to the cumulative offset corresponding to the (N−1)-th dimension of the first tensor, update a cumulative offset corresponding to a (N−1)-th dimension of the second tensor by adding an offset corresponding to the (N−1)-th dimension of the second tensor to the cumulative offset corresponding to the (N−1)-th dimension of the second tensor, and perform the determination of whether the current variable is smaller than a larger dimension size among the dimension size of the current dimension of the first tensor and the dimension size of the current dimension of the second tensor by updating the (N−1)-th variable to the current variable and updating the (N−1)-th dimension to the current dimension.

The one or more processors may be further configured to, in response to a value of an N-th dimension of the broadcasting type being a first value, determine an offset corresponding to the N-th dimension of the first tensor as an offset corresponding to the N-th dimension of the first shape, and determine an offset corresponding to the N-th dimension of the second tensor as an offset corresponding to the N-th dimension of the second shape, in response to the value of the N-th dimension of the broadcasting type being a second value, determine the offset corresponding to the N-th dimension of the first tensor as a second specific value, and determine the offset corresponding to the N-th dimension of the second tensor as the offset corresponding to the N-th dimension of the second shape, and, in response to the value of the N-th dimension of the broadcasting type being a third value, determine the offset corresponding to the N-th dimension of the first tensor as the offset corresponding to the N-th dimension of the first shape, and determine the offset corresponding to the N-th dimension of the second tensor as the second specific value, and that the Nis a natural number less than or equal to M, a total number of dimensions of the first tensor and the second tensor, and greater than or equal to 1.

The one or more processors may be further configured to determine respective first dimension values of each dimension except a rightmost dimension of a first offset of the first shape as a product of dimension sizes of next dimensions of a corresponding dimension of the first shape and determine a third dimension value of the rightmost dimension of the offset of the first shape as a third specific value, and determine respective second dimension values of each dimension except a rightmost dimension of a second offset of the second shape as a product of dimension sizes of next dimensions of a corresponding dimension of the second shape, and determine a fourth dimension value of the rightmost dimension of the offset of the second shape as the third specific value.

Other features and aspects will be apparent from the following detailed description, the drawings, and the claims.

### BRIEF DESCRIPTION OF THE DRAWINGS

FIG. 1 illustrates an example method of operating an electronic device according to one or more embodiments.

FIG. 2 illustrates an example method of determining a broadcasting type according to one or more embodiments.

FIG. 3 illustrates an example process of determining an offset for each dimension of a shape according to one or more embodiments.

FIG. 4 illustrates an example method of determining an offset for each dimension of a tensor according to one or more embodiments.

FIG. 5 illustrates an example method of performing an operation of determining an offset according to one or more embodiments.

FIG. 6 illustrates an example process of merging of dimensions according to one or more embodiments.

FIG. 7 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

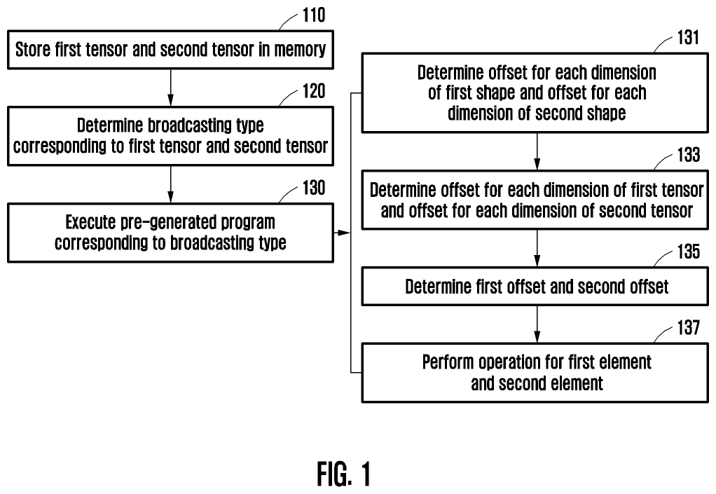

FIG. 1 illustrates an example method of operating an electronic device according to one or more embodiments.

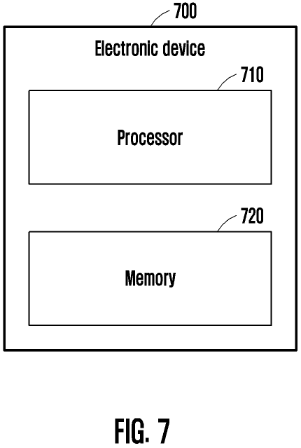

Referring to FIG. 1, in a non-limiting example, a method may perform operations in an electronic device (i.e., electronic device 700 of FIG. 7) to perform tensor broadcasting operations. In the following examples, operations may be performed sequentially but not necessarily. For example, the order of the operations may be changed and at least two of the operations may be performed in parallel. Further, in some examples, a portion of the operations may be omitted. Operations 110 to 130 and operations 131 to 137 may be performed by at least one component (e.g., a processor) of the electronic device. For example, instructions stored in a memory may be executed individually and/or collectively by at least one processor, and the instructions may cause the electronic device to perform operations 110 to 130 and operations 131 to 137.

In an example, in operation 110, the electronic device may store a first tensor arranged in a specific dimensional order in the memory. The electronic device may store a second tensor arranged in a specific dimensional order in the memory. In an example, the first tensor and the second tensor may be extracted from one or more images. The electronic device may obtain an image processing result by performing a predetermined operation for the first tensor and the second tensor. The predetermined operation may include one or more of addition, subtraction, multiplication, or division.

A shape of a tensor may include a dimension size corresponding to each dimension of the tensor. For example, it may be assumed that the shape of the first tensor is represented as (6, 4, 5). Therefore, the dimension number of the first tensor may be 3. In other words, the first tensor may have three dimensions or axes. A leftmost dimension of the first tensor is a first dimension and the dimension size thereof may be 6. A middle dimension of the first tensor is a second dimension and the dimension size thereof may be 4. A rightmost dimension of the first tensor is a third dimension and the dimension size thereof may be 5.

In an example, the first tensor and the second tensor may be tensors that may be used to perform a broadcasting operation. The broadcasting operation may refer to a method of matching patterns of shapes to perform an operation even when a first shape of the first tensor and a second shape of the second tensor are different from each other. In order to be used to perform the broadcasting operation, it is desired that the first shape and the second shape both have the same dimension number. For example, the first shape and the second shape may have the same dimension number, 3. In order to perform the broadcasting operations when the first shape and the second shape have different dimension sizes in a corresponding dimension, the dimension size of one of the first shape or the second shape in the dimension having different dimension sizes may be 1. For example, when the first shape of the first tensor is (6, 4, 1) and the second shape of the second tensor is (6, 4, 5), the first shape and the second shape have different dimension sizes in the third dimension and the first shape has a dimension size of 1 in the third dimension, and thus, they may be used to perform the broadcasting operation. In another example, when the first shape of the first tensor is (6, 4, 2) and the second shape of the second tensor is (6, 4, 5), both the first shape and the second shape have different dimension sizes, not having a dimension size of 1 in any dimension, including the third dimension having different dimension sizes, and thus, these example tensors may not be used to perform the broadcasting operation.

In an example, when the dimension number of the first tensor and the dimension number of the second tensor are different, the electronic device may complement the shape of the tensor having a smaller dimension number among the first tensor and the second tensor by using 1. In other words, the shape of the tensor having a smaller dimension number may be complemented using 1 to make the first tensor and the second tensor have the same dimension number. For example, when the first shape of the first tensor is (3, 4) and the second shape of the second tensor is (2, 3, 4), the first tensor has a smaller dimension number than the second number and the electronic device may complement the first shape of the first tensor to (1, 3, 4) by adding 1 to a leftmost side of the first shape of the first tensor.

In an example, the electronic device may store the first tensor and the second tensor arranged in order from a lowest dimension to a highest dimension in the memory of the processor (e.g., a central processing unit (CPU)). It should be understood that those skilled in the art may use any known method for arranging tensors, and the present disclosure is not limited thereto.

In operation 120, in an example, the electronic device may determine a broadcasting type corresponding to the first tensor and the second tensor based on the first shape of the first tensor and the second shape of the second tensor.

In an example, the broadcasting type may indicate whether the first tensor and/or the second tensor need to be broadcast (i.e., extended) in each dimension. For example, when a value of the broadcasting type is 0, it may indicate that the first tensor and the second tensor do not need to be extended. For example, when the value of the broadcasting type is 1, it may indicate that only the first tensor needs to be extended. For example, when the value of the broadcasting type is 2, it may indicate that only the second tensor needs to be extended.

For example, when the broadcasting type is (0, 1, 2), it may indicate that the first tensor and the second tensor do not need to be extended in the first dimension, only the first tensor needs to be extended in the second dimension, and only the second tensor needs to be extended in the third dimension.

In an example, the electronic device may determine the broadcasting type by comparing the first shape of the first tensor and the second shape of the second tensor for each dimension. When the first shape and the second shape have the same dimension sizes in a corresponding dimension, the electronic device may determine the value of the broadcasting type of the corresponding dimension as a first value (e.g., 0). In other words, the electronic device may determine the value of the broadcasting type as the first value when there is no need to extend both the first tensor and the second tensor in the corresponding dimension. When the first shape and the second shape do not have the same dimension size in the corresponding dimension and the first shape has a dimension size of 1 in the corresponding dimension, the electronic device may determine the value of the broadcasting type as a second value (e.g., 1). In other words, the electronic device may determine the value of the broadcasting type as the second value when only the first tensor needs to be extended in the corresponding dimension. When the first shape and the second shape do not have the same dimension size in the corresponding dimension and the second shape has a dimension size of 1 in the corresponding dimension, the electronic device may determine the value of the broadcasting type as a third value (e.g., 2). In other words, the electronic device may determine the value of the broadcasting type as the third value when only the second tensor needs to be extended in the corresponding dimension.

Therefore, the dimension number of the broadcasting type may be the same as the dimension number of the first tensor and the second tensor.

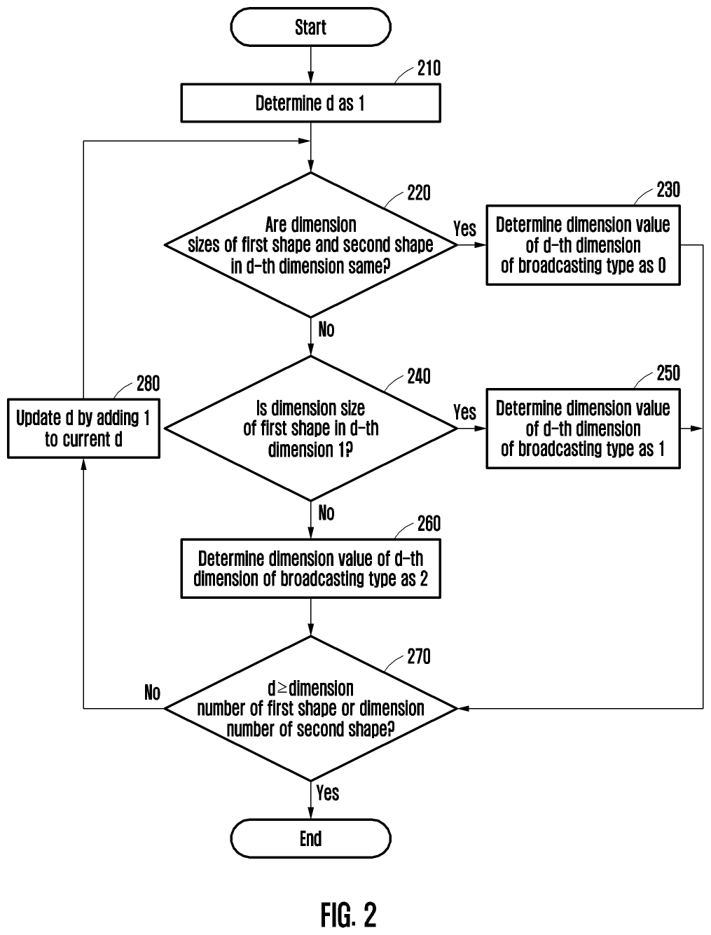

A method of determining the broadcasting type will be described in greater detail below with reference to FIG. 2.

In operation 130, in an example, the electronic device may execute a pre-generated program corresponding to the broadcasting type. The electronic device may perform an operation by extending the first tensor and/or the second tensor by executing the pre-generated program.

In an example, operation 130 may include operations 131 to 137 below.

In operation 131, in an example, the electronic device may determine an offset for each dimension of the first shape based on the first shape, and determine an offset for each dimension of the second shape based on the second shape.

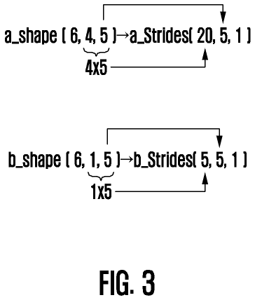

A method of determining the offset for each dimension will be described in greater detail below with reference to FIG. 3.

In operation 133, in an example, the electronic device may determine an offset for each dimension of the first tensor and an offset for each dimension of the second tensor based on the broadcasting type, the offset for each dimension of the first shape, and the offset for each dimension of the second shape.

The electronic device may determine the offset for each dimension of the first tensor and the offset for each dimension of the second tensor based on whether the first tensor and the second tensor need to be extended in each dimension.

In an example, when a value of a specific dimension of the broadcasting type is the first value (e.g., 0) (i.e., when the first tensor and the second tensor do not need to be extended), the electronic device may determine an offset corresponding to the specific dimension of the first tensor as an offset corresponding to the specific dimension of the first shape. When the value of the specific dimension of the broadcasting type is the first value, the electronic device may determine an offset corresponding to the specific dimension of the second tensor as an offset corresponding to the specific dimension of the second shape.

In an example, when the value of the specific dimension of the broadcasting type is the second value (e.g., 1) (i.e., when the first tensor needs to be extended in the specific dimension), the electronic device may determine the offset corresponding to the specific dimension of the first tensor as 0. When the value of the specific dimension of the broadcasting type is the second value, the electronic device may determine the offset corresponding to the specific dimension of the second tensor as the offset corresponding to the specific dimension of the second shape. At this time, in the specific dimension, the number of elements of the first tensor may be only 1, and the number of elements of the second tensor may be more than 1. Therefore, since the number of elements of the first tensor is 1 in the specific dimension, the electronic device may offset the second tensor in the specific dimension so that the plurality of elements present in the specific dimension of the second tensor may be operated with one element present in the specific dimension of the first tensor.

In an example, when the value of the specific dimension of the broadcasting type is the third value (e.g., 2) (i.e., when the second tensor needs to be extended in the specific dimension), the electronic device may determine the offset corresponding to the specific dimension of the second tensor as 0. When the value of the specific dimension of the broadcasting type is the third value, the electronic device may determine the offset corresponding to the specific dimension of the first tensor as the offset corresponding to the specific dimension of the first shape. At this time, in the specific dimension, the number of elements of the second tensor may be only 1, and the number of elements of the first tensor may be more than 1. Therefore, since the number of elements of the second tensor is 1 in the specific dimension, the electronic device may offset the second tensor in the specific dimension so that the plurality of elements present in the specific dimension of the first tensor may be operated with one element present in the specific dimension of the second tensor.

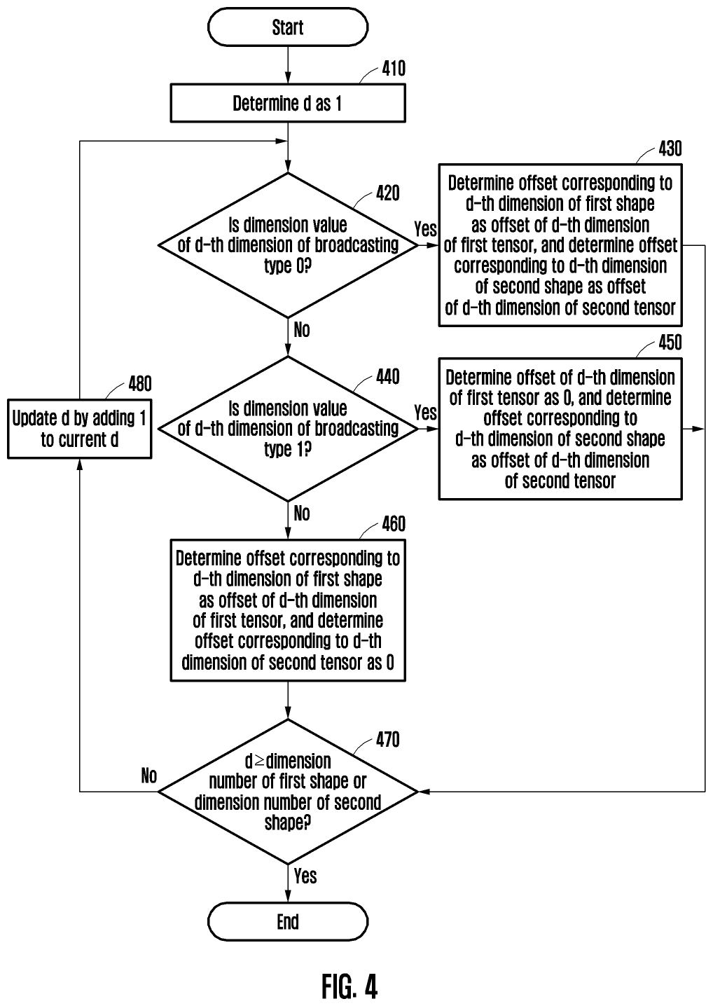

A method of determining the offset of the tensor will be described in greater detail below with reference to FIG. 4.

In operation 135, in an example, the electronic device may determine a first offset and a second offset based on the offset for each dimension of the first tensor and the offset for each dimension of the second tensor. The first offset may be an offset for a first element of the first tensor, on which an operation is to be performed. The second offset may be an offset for a second element of the second tensor, on which an operation is to be performed.

In an example, the electronic device may determine a cumulative offset for each dimension of the first tensor and a cumulative offset for each dimension of the second tensor based on the offset for each dimension of the first tensor and the offset for each dimension of the second tensor.

In an example, the electronic device may determine a cumulative offset for the first tensor based on a sum of the cumulative offsets for each dimension of the first tensor. The electronic device may determine a cumulative offset for the second tensor based on a sum of the cumulative offsets for each dimension of the second tensor.

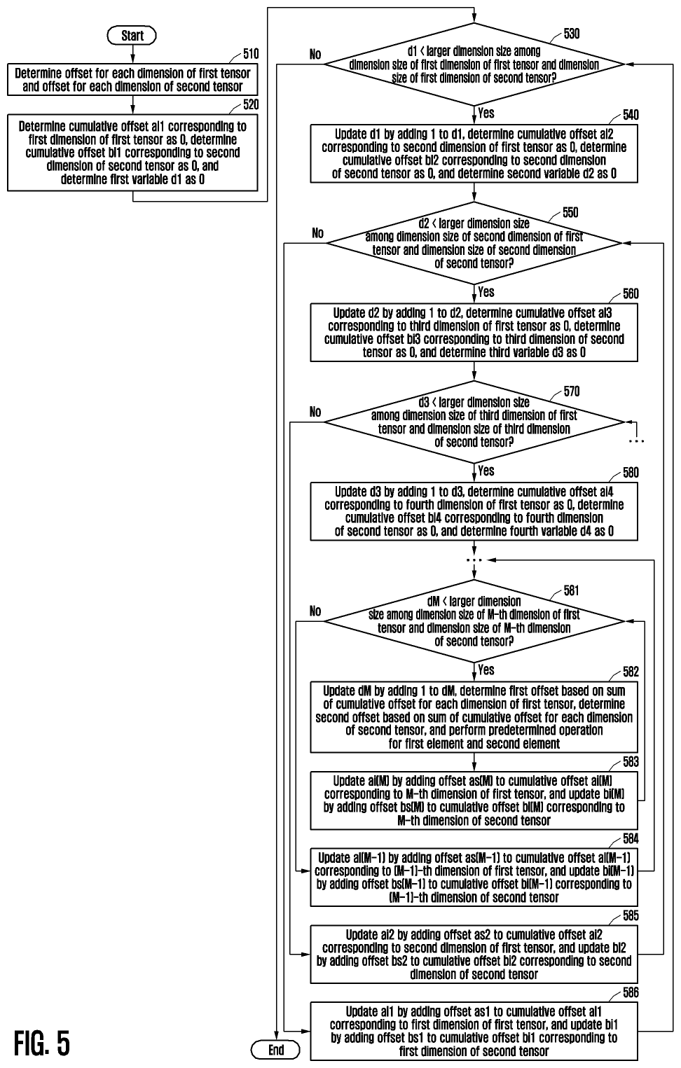

In an example, the electronic device may determine the first offset based on the cumulative offset for the first tensor. The electronic device may determine the second offset based on the cumulative offset for the second tensor. A method of determining the first offset and the second offset will be described in greater detail below with reference to FIG. 5.

In operation 137, in an example, the electronic device may perform an operation on the first element and the second element. The electronic device may obtain the first element and the second element from the memory based on the first offset and the second offset. The electronic device may perform a predetermined operation on the obtained first and second elements.

In an example, the electronic device may determine a first storage position in the memory for the first element to perform the predetermined operation based on the first offset. The electronic device may determine a second storage position in the memory for the second element to perform the predetermined operation based on the second offset.

In an example, the electronic device may determine the first storage position based on a first start position of a start element of the first tensor and the first offset. The electronic device may determine the second storage position based on a second start position of a start element of the second tensor and the second offset.

In an example, the electronic device may perform the predetermined operation on the first element and the second element.

In an example, the electronic device may determine the first shape and the second shape by reducing the shape of the first tensor and the shape of the second tensor. The electronic device may perform operations 110 to 130 and operations 131 to 137 as described above based on the first shape and the second shape, which are reduced from the shape of the first tensor and the shape of the second tensor.

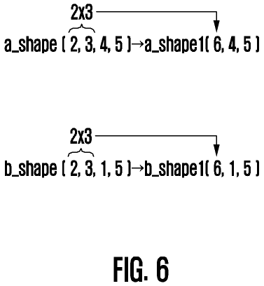

In an example, when the shape of the first tensor and the shape of the second tensor have the same dimension size in at least two consecutive dimensions, the electronic device may determine the first shape and the second shape by merging the at least two consecutive dimensions. The merging of dimensions will be described in greater detail below with reference to FIG. 6.

In an example, the electronic device may pre-generate a program for an operation corresponding to each broadcasting type before receiving a tensor. By pre-generating the program for the operation, the time for program generation may be reduced, which may improve efficiency.

In an example, in consideration of the storage capacity of the memory, the electronic device may pre-generate a program for an operation corresponding to the broadcasting type with less than four dimensions. The electronic device may generate a program for an operation for the broadcasting type with equal to or more than four dimensions after receiving a tensor, and may execute the corresponding program. The program may include a program that performs operations 120, 130, and 131 to 137.

FIG. 2 illustrates an example method of determining a broadcasting type according to one or more embodiments.

In the following examples, operations may be performed sequentially but not necessarily. For example, the order of the operations may be changed and at least two of the operations may be performed in parallel. Further, in some examples, a portion of the operations may be omitted. Operations 210 to 280 may be performed by at least one component (e.g., a processor) of the electronic device. For example, instructions stored in a memory may be executed individually and/or collectively by at least one processor, and the instructions may cause the electronic device to perform operations 210 to 280.

Referring to FIG. 2, in a non-limiting example, a method may include operation 210, in which the electronic device (e.g., electronic device 700 of FIG. 7) may set d to an initial value of 1. In addition, d may be a variable.

In operation 220, in an example, the electronic device may determine whether the first shape and the second shape have the same dimension size in a d-th dimension. When the first shape and the second shape have the same dimension size in the d-th dimension, the electronic device may perform operation 230. When the first shape and the second shape do not have the same dimension size in the d-th dimension, the electronic device may perform operation 240.

In operation 230, in an example, the electronic device may determine a dimension value of the d-th dimension of the broadcasting type as 0.

In operation 240, in an example, the electronic device may determine whether the dimension size of the first shape in the d-th dimension is 1. When the dimension size of the first shape in the d-th dimension is 1, the electronic device may perform operation 250. When the dimension size of the first shape in the d-th dimension is not 1, the electronic device may perform operation 260.

In operation 250, in an example, the electronic device may determine the dimension value of the d-th dimension of the broadcasting type as 1.

In operation 260, in an example, the electronic device may determine the dimension value of the d-th dimension of the broadcasting type as 2.

In operation 270, in an example, the electronic device may determine whether d is greater than or equal to the dimension number of the first shape or the dimension number of the second shape. When d is greater than or equal to the dimension number of the first shape or the dimension number of the second shape, the electronic device may end the operation of determining the broadcasting type. When d is less than the dimension number of the first shape or the dimension number of the second shape, the electronic device may perform operation 280.

In operation 280, in an example, the electronic device may update d by adding 1 to the current d.

The electronic device may perform operations 220 to 280 using the updated d. In other words, the electronic device may sequentially determine the broadcasting type for each dimension of the first shape and the second shape.

For example, it may be assumed that a first shape a_shape of a first tensor a is (m, n, 1) and that a second shape b_shape of a second tensor b is (m, 1, x). In addition, m, n, and x may be natural numbers. However, the shapes of the first tensor a and the second tensor b described above are merely examples, and the present disclosure is not limited thereto. In other words, the first tensor a and the second tensor b may be of any shape that may be used for broadcasting operations. At this time, the broadcasting type may be determined as (0, 2, 1).

Hereinafter, a method of determining an offset for each dimension of a shape will be described in greater detail below.

FIG. 3 illustrates an example process of determining an offset for each dimension of a shape according to one or more examples.

Referring to FIG. 3, in a non-limiting example, in the example process, it may be assumed that the first shape a_shape of the first tensor a is (6, 4, 5) and the second shape b_shape of the second tensor b is (6, 1, 5). However, the shapes of the first tensor a and the second tensor b described above are merely examples, and the present disclosure is not limited thereto. In other words, the first tensor a and the second tensor b may be of any shape that may be used for broadcasting operations.

In an example, the electronic device (e.g., electronic device 700 of FIG. 7) may determine an offset corresponding to each dimension of the first shape. The electronic device may determine an offset of each dimension except a rightmost dimension of the first shape based on at least one next dimension. When the number of the at least one next dimension is two or more, the electronic device may determine the offset as a product of dimension sizes of the next dimensions. When the number of the at least one next dimension is one, the electronic device may determine the dimension size of the one next dimension as the offset. The electronic device may determine the offset of the rightmost dimension of the first shape as a specific value (e.g., 1).

For example, since the first shape a_shape is (6, 4, 5), the number of the next dimensions of the first dimension may be two (i.e., a second dimension and a third dimension). The electronic device may determine the offset of the first dimension as the product of the dimension sizes of the next dimensions (i.e., 4×5=20). Since the first shape a_shape is (6, 4, 5), the number of the next dimensions of the second dimension may be one (i.e., the third dimension). The electronic device may determine a dimension size, 5, of the next dimension as the offset of the second dimension. The electronic device may determine the offset of the rightmost dimension as the specific value.

The electronic device may determine the offset corresponding to each dimension of the second shape. The electronic device may determine the offset of each dimension except the rightmost dimension of the second shape based on the at least one next dimension. When the number of the at least one next dimension is two or more, the electronic device may determine the offset by the product of the dimension sizes of the next dimensions. When the number of the at least one next dimension is one, the electronic device may determine the dimension size of the one next dimension as the offset. The electronic device may determine the offset of the rightmost dimension of the second shape to the specific value (e.g., 1). Therefore, a_Strides, the offset for each dimension of the first shape, may be determined as (20, 5, 1).

For example, since the second shape b_shape is (6, 1, 5), the number of the next dimensions of the first dimension may be two (i.e., the second dimension and the third dimension). The electronic device may determine the offset of the first dimension by the product of the dimension sizes of the next dimensions (i.e., 1×5=5). Since the second shape b_shape is (6, 1, 5), the number of the next dimensions of the second dimension may be one (i.e., the third dimension). The electronic device may determine the dimension size, 5, of the next dimension as the offset of the second dimension. The electronic device may determine the offset of the rightmost dimension as the specific value. Therefore, b_Strides, the offset for each dimension of the second shape, may be determined as (5, 5, 1).

Hereinafter, a method of determining an offset for each dimension of a tensor based on an offset for each dimension determined by the above method will be described in greater detail below.

FIG. 4 illustrates an example method of determining an offset for each dimension of a tensor according to one or more embodiments.

In the following examples, operations may be performed sequentially but not necessarily. For example, the order of the operations may be changed and at least two of the operations may be performed in parallel. Further, in some examples, a portion of the operations may be omitted. Operations 410 to 480 may be performed by at least one component (e.g., a processor) of an electronic device. For example, instructions stored in a memory may be executed individually and/or collectively by at least one processor, and the instructions may cause the electronic device to perform operations 410 to 480.

Referring to FIG. 4, in a non-limiting example, a method may include operation 410 in which the electronic (e.g., electronic device 700 of FIG. 7) device may determine d as 1. Here, d may be a variable.

In operation 420, in an example, the electronic device may determine whether a dimension value of a d-th dimension of a broadcasting type is 0. When the dimension value of the d-th dimension of the broadcasting type is 0, the electronic device may perform operation 430. When the dimension value of the d-th dimension of the broadcasting type is not 0, the electronic device may perform operation 440.

In operation 430, in an example, the electronic device may determine an offset corresponding to the d-th dimension of the first shape as an offset of the d-th dimension of the first tensor, and determine an offset corresponding to the d-th dimension of the second shape as an offset of the d-th dimension of the second tensor.

In other words, the electronic device may determine an offset asd corresponding to the d-th dimension of the first tensor a as an offset of the d-th dimension of a Strides. The electronic device may determine an offset bsd corresponding to the d-th dimension of the second tensor b as an offset of the d-th dimension of b_Strides.

In operation 440, in an example, the electronic device may determine whether the dimension value of the d-th dimension of the broadcasting type is 1. When the dimension value of the d-th dimension of the broadcasting type is 1, the electronic device may perform operation 450. When the dimension value of the d-th dimension of the broadcasting type is not 1, the electronic device may perform operation 460.

In operation 450, in an example, the electronic device may determine the offset of the d-th dimension of the first tensor as 0, and determine the offset corresponding to the d-th dimension of the second shape as the offset of the d-th dimension of the second tensor.

In other words, the electronic device may determine the offset asd corresponding to the d-th dimension of the first tensor a as 0. The electronic device may determine the offset bsd corresponding to the d-th dimension of the second tensor b as the offset of the d-th dimension of b_Strides.

In operation 460, in an example, the electronic device may determine the offset corresponding to the d-th dimension of the first shape as the offset of the d-th dimension of the first tensor, and determine the offset corresponding to the d-th dimension of the second tensor as 0.

In other words, the electronic device may determine the offset asd corresponding to the d-th dimension of the first tensor a as the offset of the d-th dimension of a Strides. The electronic device may determine the offset bsd corresponding to the d-th dimension of the second tensor b as 0.

In operation 470, in an example, the electronic device may determine whether d is greater than or equal to the dimension number of the first shape or the dimension number of the second shape. When d is greater than or equal to the dimension number of the first shape or the dimension number of the second shape, the electronic device may end the operation of determining the offset for each dimension of the tensor. When d is less than the dimension number of the first shape or the dimension number of the second shape, the electronic device may perform operation 480.

In operation 480, in an example, the electronic device may update d by adding 1 to the current d.

The electronic device may perform operations 420 to 470 using the updated d. In other words, the electronic device may sequentially determine the offset for each dimension of the first tensor and the second tensor.

For example, it may be assumed that the first shape a_shape of the first tensor a is (6, 4, 1) and that the second shape b_shape of the second tensor b is (6, 1, 5). However, the shapes of the first tensor a and the second tensor b described above are merely examples, and the present disclosure is not limited thereto. In other words, the first tensor a and the second tensor b may be of any shape that may be used for broadcasting operations.

At this time, the broadcasting type may be determined as (0, 2, 1) according to the above description with reference to FIG. 2. At this time, the offset a Strides for each dimension of the first shape and the offset b_Strides for each dimension of the second shape may be determined as (4, 1, 1) and (5, 5, 1), respectively, according to the method described above with reference to FIG. 3. The electronic device may determine offsets as1, as2, and as3 corresponding to the dimensions of the first tensor as 4, 1, and 0 (i.e., (4, 1, 0)) based on operations 410 to 480. The electronic device may determine offsets bs1, bs2, and bs3 corresponding to the dimensions of the second tensor as 5, 0, and 1 (i.e., (5, 0, 1)) based on operations 410 to 480.

Hereinafter, a method of performing an operation by an electronic device will be described in greater detail below.

FIG. 5 illustrates an example method of performing an operation of determining an offset according to one or more embodiments.

In the following examples, operations may be performed sequentially but not necessarily. For example, the order of the operations may be changed and at least two of the operations may be performed in parallel. Further, in some examples, a portion of the operations may be omitted. Operations 510 to 580 and operations 581 to 586 may be performed by at least one component (e.g., a processor) of an electronic device. For example, instructions stored in a memory may be executed individually and/or collectively by at least one processor, and the instructions may cause the electronic device to perform operations 510 to 580 and operations 581 to 586.

Referring to FIG. 5, in a non-limiting example, the electronic device (e.g., electronic device 700 of FIG. 7) may determine an offset for each dimension of a first tensor and an offset for each dimension of a second tensor in operation 510. The method of determining the offset for each dimension of the first tensor and the offset for each dimension of the second tensor has been described above with reference to FIGS. 1 to 4, and thus, the description thereof will be omitted.

In an example, asd may represent an offset of a d-th dimension in a first tensor a, and bsd may represent an offset of a d-th dimension in a second tensor b. In addition, aid may represent a cumulative offset corresponding to the d-th dimension of the first tensor a, and bid may represent a cumulative offset corresponding to the d-th dimension of the second tensor b. In addition, d may be a natural number of 1 to M. Finally, M may be a dimension number of the first tensor a and the second tensor b.

In operation 520, in an example, the electronic device may determine a cumulative offset ai1 corresponding to a first dimension of a first tensor (i.e., the first tensor a) as a specific value (e.g., 0), and determine a cumulative offset bi1 corresponding to a second dimension of a second tensor (i.e., the second tensor b) as a specific value (e.g., 0). The electronic device may determine a first variable d1 as a specific value (e.g., 0). In other words, the electronic device may determine initial values of ai1, bi1, and d1 as the specific values.

In operation 530, in an example, the electronic device may determine whether d1 is smaller than a larger dimension size among a dimension size of the first dimension of the first tensor and a dimension size of the first dimension of the second tensor. When d1 is greater than or equal to the larger dimension size among the dimension size of the first dimension of the first tensor and the dimension size of the first dimension of the second tensor, the flowchart of FIG. 5 may end. When d1 is smaller than the larger dimension size among the dimension size of the first dimension of the first tensor and the dimension size of the first dimension of the second tensor, the electronic device may perform operation 540.

In operation 540, in an example, the electronic device may update d1 by adding 1 to d1. The electronic device may determine a cumulative offset ai2 corresponding to a second dimension of the first tensor as a specific value (e.g., 0), and determine a cumulative offset bi2 corresponding to a second dimension of the second tensor as a specific value (e.g., 0). The electronic device may determine a second variable d2 as a specific value (e.g., 0). In other words, the electronic device may update the first variable, and determine initial values of ai2, bi2, and d2 as the specific values.

In operation 550, in an example, the electronic device may determine whether d2 is smaller than a larger dimension size among a dimension size of the second dimension of the first tensor and a dimension size of the second dimension of the second tensor. When d2 is greater than or equal to the larger dimension size among the dimension size of the second dimension of the first tensor and the dimension size of the second dimension of the second tensor, the electronic device may perform operation 586. When d2 is smaller than the larger dimension size among the dimension size of the second dimension of the first tensor and the dimension size of the second dimension of the second tensor, the electronic device may perform operation 560.

In operation 586, in an example, the electronic device may update ai1 by adding the offset as1 to the cumulative offset ai1 corresponding to the first dimension of the first tensor, and update bi1 by adding the offset bs1 to the cumulative offset bi1 corresponding to the first dimension of the second tensor. In other words, the electronic device may update the cumulative offset corresponding to the first dimension of the first tensor and the cumulative offset corresponding to the first dimension of the second tensor. After performing operation 586, the electronic device may perform operation 530 again.

In operation 560, in an example, the electronic device may update d2 by adding 1 to d2. The electronic device may determine a cumulative offset ai3 corresponding to a third dimension of the first tensor as a specific value (e.g., 0), determine a cumulative offset bi3 corresponding to a third dimension of the second tensor as a specific value (e.g., 0), and determine a third variable d3 as a specific value (e.g., 0). In other words, the electronic device may determine initial values of ai3, bi3, and d3 as the specific values.

In operation 570, in an example, the electronic device may determine whether d3 is smaller than a larger dimension size among a dimension size of the third dimension of the first tensor and a dimension size of the third dimension of the second tensor. When d3 is greater than or equal to the larger dimension size of the third dimension of the first tensor and the third dimension of the second tensor, the electronic device may perform operation 585. When d3 is smaller than the larger dimension size of the third dimension of the first tensor and the third dimension of the second tensor, the electronic device may perform operation 580.

In operation 580, in an example, the electronic device may update d3 by adding 1 to d3. The electronic device may determine a cumulative offset ai4 corresponding to a fourth dimension of the first tensor as a specific value (e.g., 0), determine a cumulative offset bi4 corresponding to a fourth dimension of the second tensor as a specific value (e.g., 0), and determine a fourth variable d4 as a specific value (e.g., 0).

After operation 580, the operation of comparing the variable and the dimension size described above, the operation of updating the variable and determining the initial value of the cumulative offset as a specific value described above, and the operation of updating the cumulative offset described above may be repeated, and thus the description thereof will be omitted.

In operation 585, in an example, the electronic device may update ai2 by adding the offset as2 to the cumulative offset ai2 corresponding to the second dimension of the first tensor, and update bi2 by adding the offset bs2 to the cumulative offset bi2 corresponding to the second dimension of the second tensor. In other words, the electronic device may update the cumulative offset corresponding to the second dimension of the first tensor and the cumulative offset corresponding to the second dimension of the second tensor. After performing operation 585, the electronic device may perform operation 550 again.

In operation 581, in an example, the electronic device may determine whether dM is smaller than a larger dimension size among a dimension size of an M-th dimension of the first tensor and a dimension size of an M-th dimension of the second tensor. When dM is greater than or equal to the larger dimension size among the dimension size of the M-th dimension of the first tensor and the dimension size of the M-th dimension of the second tensor, the electronic device may perform operation 584. When dM is smaller than the larger dimension size among the dimension size of the M-th dimension of the first tensor and the dimension size of the M-th dimension of the second tensor, the electronic device may perform operation 582. Here, M may be a dimension number of the first tensor and the second tensor.

In operation 582, in an example, the electronic device may update dM by adding 1 to dM. The electronic device may determine the first offset based on a sum of the cumulative offsets for each dimension of the first tensor, and determine the second offset based on a sum of the cumulative offsets for each dimension of the second tensor. The electronic device may perform a predetermined operation for the first element and the second element.

In other words, the electronic device may determine the sum of ai1, ai2, ai3, . . . , and aiM. The electronic device may determine the sum of ai1, ai2, ai3, . . . , and aiM as the first offset. The electronic device may determine the sum of bi1, bi2, bi3, . . . , and biM. The electronic device may determine the sum of bi1, bi2, bi3, . . . , and biM as the second offset.

The electronic device may determine a first storage position of the first element of the first tensor based on the first offset, and determine a second storage position of the second element of the second tensor based on the second offset. The electronic device may obtain the first element and the second element based on the first storage position and the second storage position. The electronic device may perform the predetermined operation for the first element and the second element.

In operation 583, in an example, the electronic device may update ai(M) by adding the offset as(M) to the cumulative offset ai(M) corresponding to the M-th dimension of the first tensor, and update bi(M) by adding the offset bs(M) to the cumulative offset bi(M) corresponding to the M-th dimension of the second tensor. In other words, the electronic device may update the cumulative offset corresponding to the M-th dimension of the first tensor and the cumulative offset corresponding to the M-th dimension of the second tensor. After performing operation 583, the electronic device may perform operation 581 again.

In operation 584, in an example, the electronic device may update ai(M-1) by adding the offset as(M-1) to the cumulative offset ai(M-1) corresponding to the M-1-th dimension of the first tensor, and update bi(M-1) by adding the offset bs(M-1) to the cumulative offset bi(M-1) corresponding to the M-1-th dimension of the second tensor. Then, the electronic device may determine whether d(M-2) is smaller than a larger dimension size among a dimension size of a(M-2)-th dimension of the first tensor and a dimension size of a(M-2)-th dimension of the second tensor.

In other words, the electronic device may determine an N-th variable as a current variable and an N-th dimension as a current dimension. The electronic device may determine whether a current variable is smaller than a larger dimension size among a dimension size of a current dimension of the first tensor and a dimension size of a current dimension of the second tensor. In addition, N may be a natural number less than or equal to M, a total number of dimensions of the first tensor and the second tensor, and greater than or equal to 1.

When N is greater than or equal to 1 and less than M, and the current variable is smaller than the larger dimension size among the dimension size of the current dimension of the first tensor and the dimension size of the current dimension of the second tensor, the electronic device may update the current variable (i.e., dN) by adding 1 to the current variable, and determine the cumulative offsets (i.e., ai(N+1) and bi(N+1)) of a(N+1)-th dimension of the first tensor and the second tensor as a specific value (e.g., 0). The electronic device may determine a(N+1)-th variable (i.e., d(N+1)) as a specific value (e.g., 0). The electronic device may update the (N+1)-th variable (d(N+1)) to the current variable, and update the (N+1)-th dimension to the current dimension. The electronic device may determine whether the current variable (i.e., d(N+1)) is smaller than a larger dimension size among a dimension size of the current dimension (i.e., the (N+1)-th dimension) of the first tensor and a dimension size of the current dimension of the second tensor.

When N is equal to M and the current variable (i.e., dN) is smaller than a larger dimension size among a dimension size of the current dimension (i.e., an N-th dimension) of the first tensor and a dimension size of the current dimension of the second tensor, the electronic device may update the N-th variable by adding 1 to the N-th variable, determine the first offset based on the sum of the cumulative offsets for each dimension of the first tensor, and determine the second offset based on the sum of the cumulative offsets for each dimension of the second tensor. The electronic device may perform a predetermined operation by obtaining the first element and the second element based on the first offset and the second offset.

When N is greater than 1 and less than or equal to M, and the current variable (i.e., dN) is greater than or equal to the larger dimension size among the dimension size of the current dimension (i.e., the N-th dimension) of the first tensor and the dimension size of the current dimension (i.e., the N-th dimension) of the second tensor, the electronic device may update the cumulative offset corresponding to the (N−1)-th dimension of the first tensor by adding an offset (i.e., ai(N−1)) corresponding to the (N−1)-th dimension of the first tensor to the cumulative offset (i.e., as(N−1)) corresponding to the (N−1)-th dimension of the first tensor, and update the cumulative offset corresponding to the (N−1)-th dimension of the second tensor by adding an offset (i.e., bi(N−1)) corresponding to the (N−1)-th dimension of the second tensor to the cumulative offset (i.e., bs(N−1)) corresponding to the (N−1)-th dimension of the second tensor. The electronic device may update the (N−1)-th variable d(N−1) to the current variable, and update the (N−1)-th dimension to the current dimension. The electronic device may determine whether the current variable (i.e., d(N−1)) is smaller than a larger dimension size among a dimension size of the current dimension (i.e., the (N−1)-th dimension) of the first tensor and a dimension size of the current dimension of the second tensor.

When N is 1 and the current variable (i.e., dN) is greater than or equal to the larger dimension size among the dimension size of the current dimension (i.e., the N-th dimension) of the first tensor and the dimension size of the current dimension of the second tensor, the electronic device may end the operations of FIG. 5.

The electronic device may also support operations for tensors of various dimensions through the above-described method. In particular, the electronic device may also support operations for tensors of four or more dimensions through the above-described method.

The code for implementing the operations of the comparison described in FIG. 5 (e.g., operations 530, 550, 570, and 581) may not include logical determination branches. The code for implementing the above-described operations of FIG. 5 may include a plurality of loops corresponding to the number of dimensions of the first tensor and the second tensor. The electronic device may determine a memory position of a tensor element through a plurality of loops that include addition operations instead of multiplication operations. The code used to implement the above-described plurality of loops may be optimized through a compiler's automatic vectorization function, which may improve the execution performance of the code used to implement the broadcasting operation. Also, the broadcasting operation may be applied to a tensor of various dimensions by including the plurality of loops that replace multiplication operations with addition operations to find the memory position of the tensor element.

FIG. 6 illustrates an example process of merging of dimensions according to one or more embodiments.

According to an example, when the shape of the first tensor and the shape of the second tensor have the same dimension size in at least two consecutive dimensions, the electronic device (e.g., electronic device 700 of FIG. 7) may determine the first shape and the second shape by merging the at least two consecutive dimensions.

Referring to FIG. 6, in a non-limiting example, in the process, the first tensor a may have a shape of a_shape (2, 3, 4, 5) and the second tensor b may have a shape of b_shape (2, 3, 1, 5). That is, the first dimension and the second dimension of each shape may have the same size. In other words, the first dimension and the second dimension, which are consecutive dimensions, may have the same dimension size.

In an example, the electronic device may reduce dimensions by merging the first dimension and the second dimension. The electronic device may determine the product of the dimension sizes of the consecutive dimensions as the dimension size of the merged dimension. The electronic device may determine the product of the dimension sizes of the first dimension and the second dimension on the shape of the first tensor a (i.e., 2×3=6) as the dimension size of the merged dimension. The electronic device may determine the product of the dimension sizes of the first dimension and the second dimension on the shape of the second tensor b (i.e., 2×3=6) as the dimension size of the merged dimension. Therefore, the electronic device may determine the first shape of a_shape1 (6, 4, 5) by reducing the dimension of a_shape (2, 3, 4, 5). The electronic device may determine the second shape of b_shape1 (6, 1, 5) by reducing the dimension of b_shape (2, 3, 1, 5).

The electronic device may perform a predetermined operation using the method described above with reference to FIGS. 1 to 5 based on the first shape of a_shape1 (6, 4, 5) and the second shape of b_shape1 (6, 1, 5). By reducing the dimension, the operations of the comparison described above with reference to FIG. 5 may be reduced. In other words, the number of loops may be reduced. Through this, the amount of computation may be reduced. Similarly, the present disclosure may provide operations for a tensor with high dimensions by reducing the dimension.

FIG. 7 illustrates an example electronic device according to one or more embodiments.

Referring to FIG. 7, in a non-limiting example, an electronic device 700 is illustrated. The electronic device 700 may be a device having an image processing function. For example, the electronic device 700 is a device having an image processing function, and may include various computing devices, such as a mobile phone, a smartphone, a tablet personal computer (PC), an e-book device, a laptop, a PC, a desktop, a workstation, or a server, various wearable devices, such as a smart watch, smart eyeglasses, a head-mounted display (HMD), or smart clothing, various home appliances such as a smart speaker, a smart television (TV), or a smart refrigerator, and other devices, such as a smart vehicle, a smart kiosk, an Internet of things (IoT) device, a walking assist device (WAD), a drone, or a robot.

The electronic device 700 may include one or more processors 710 and a memory 720. The one or more processors 710 and the memory 720 may communicate with each other through a bus, a network on a chip (NoC), a peripheral component interconnect express (PCIe), and the like. In the example of FIG. 7, only the components related to the examples described herein are illustrated as being included in the electronic device 700. Thus, the electronic device 700 may also include other general-purpose components, in addition to the components illustrated in FIG. 7.

The one or more processors 710 may be configured to execute programs or applications to configure the one or more processors 710 to control the electronic device 700 to perform one or more or all operations and/or methods involving the broadcasting of tensors, and may include any one or a combination of two or more of, for example, a central processing unit (CPU), a graphic processing unit (GPU), a neural processing unit (NPU) and tensor processing units (TPUs), but is not limited to the above-described examples.

The memory 720 may include computer-readable instructions. The one or more processors 710 may be configured to execute computer-readable instructions, such as those stored in the memory 720, and through execution of the computer-readable instructions, the one or more processors 710 are configured to perform one or more, or any combination, of the operations and/or methods described herein. The memory 720 may be a volatile or nonvolatile memory.

For example, the at least one processor 710 may perform a broadcasting operation for a first tensor and/or a second tensor and perform a predetermined operation.

For example, the electronic device 700 may obtain one or more images from a camera installed externally or internally. The electronic device 700 may extract the first tensor and the second tensor from the one or more images and store the first tensor and the second tensor in the memory 720.

For example, the instructions may cause the electronic device to determine a broadcasting type related to extension of the first shape and the second shape based on a first shape of a first tensor and a second shape of a second tensor used in an operation with the first tensor. For example, the instructions may cause the electronic device to determine an offset for each dimension of the first shape and an offset for each dimension of the second shape based on the broadcasting type. For example, the instructions may cause the electronic device to determine an offset for each dimension of the first tensor and an offset for each dimension of the second tensor based on the broadcasting type, the offset for each dimension of the first shape, and the offset for each dimension of the second shape. For example, the instructions may cause the electronic device to determine a first offset of a first element included in the first tensor and a second offset of a second element included in the second tensor based on the offset for each dimension of the first tensor and the offset for each dimension of the second tensor. For example, the instructions may cause the electronic device to perform a predetermined operation by obtaining the first element and the second element based on the first offset and the second offset.

According to an example, the memory 720 may store a pre-generated program based on the broadcasting type. At this time, the program may have been generated in advance before the electronic device receives the first tensor and the second tensor. The one or more processors 710 may execute the pre-generated program based on the broadcasting type. The pre-generated program may perform a predetermined operation for the first tensor and the second tensor based on the broadcasting type. The pre-generated program may perform the operations described above with reference to FIGS. 1, 3 to 6. For example, the pre-generated program may determine the offset for each dimension of the first shape and the offset for each dimension of the second shape based on the broadcasting type. For example, the pre-generated program may determine the offset for each dimension of the first tensor and the offset for each dimension of the second tensor based on the broadcasting type, the offset for each dimension of the first shape, and the offset for each dimension of the second shape. For example, the pre-generated program may determine a first offset of a first element included in the first tensor and a second offset of a second element included in the second tensor based on the offset for each dimension of the first tensor and the offset for each dimension of the second tensor. For example, the pre-generated program may perform the predetermined operation by obtaining the first element and the second element based on the first offset and the second offset. However, this is merely an example and the present disclosure is not limited thereto. For example, the electronic device may generate a program corresponding to the broadcasting type after receiving the first tensor and the second tensor.

According to an example, the electronic device 700 may include a broadcasting type determination unit and a broadcast computing unit. The broadcasting type determination unit and the broadcast computing unit may be implemented as software and/or hardware. When the broadcasting type determination unit and the broadcast computing unit are implemented as software, the broadcasting type determination unit and the broadcast computing unit may be stored in the memory 720 and executed by the one or more processors 710. When the broadcasting type determination unit and the broadcast computing unit are implemented as hardware, the broadcasting type determination unit and the broadcast computing unit may be electrically connected to the one or more processors 710 and the memory 720 and controlled by the one or more processors 710. However, this is merely an example and the present disclosure is not limited thereto.

According to an example, the broadcasting type determination unit may determine the broadcasting type for each dimension based on the first shape of the first tensor and the second shape of the second tensor stored in the memory. The method of determining the broadcasting type is described above with reference to FIG. 2 and is thus omitted.

According to an example, the broadcast computing unit may determine the offset for each dimension of the first shape and the offset for each dimension of the second shape based on the broadcasting type. The broadcast computing unit may determine the offset for each dimension of the first tensor and the offset for each dimension of the second tensor based on the broadcasting type, the offset for each dimension of the first shape, and the offset for each dimension of the second shape. The broadcast computing unit may determine a first offset of a first element included in the first tensor and a second offset of a second element included in the second tensor based on the offset for each dimension of the first tensor and the offset for each dimension of the second tensor. The broadcast computing unit may perform the predetermined operation by obtaining the first element and the second element based on the first offset and the second offset. The method of determining the offset for each dimension of the shape is described above with reference to FIG. 3, the method of determining the offset for each dimension of the tensor is described above with reference to FIG. 4, and the method of determining the first offset and the second offset is described above with reference to FIG. 5, and thus, the description thereof is omitted.

The electronic devices, electronic apparatuses, processors, memories, neural networks, electronic device 700, one or more processors 710, and memory 720 described herein and disclosed herein described with respect to FIGS. 1-7 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
based on a first shape of a first tensor and a second shape of a second tensor used in an operation with the first tensor, determining a broadcasting type related to an extension of the first shape and the second shape;
determining respective first shape offsets for each dimension of the first shape and respective second shape offsets for each dimension of the second shape based on the broadcasting type;
determining respective first tensor offsets for each dimension of the first tensor and respective second tensor offsets for each dimension of the second tensor based on the broadcasting type, the respective first shape offsets for each dimension of the first shape, and the respective second shape offsets for each dimension of the second shape;
determining a first offset of a first element included in the first tensor and a second offset of a second element included in the second tensor based on the respective first tensor offsets and the respective second tensor offsets; and
performing the operation by obtaining the first element and the second element based on the first offset and the second offset.

2. The method of claim 1, wherein the determining of the respective first tensor offsets and the respective second tensor offsets comprises:
determining first respective cumulative tensor offsets for each dimension of the first tensor and second respective cumulative tensor offsets for each dimension of the second tensor based on the respective first tensor offsets and the respective second tensor offsets; and
determining the first offset and the second offset based on a sum of the first respective cumulative tensor offsets first offset and the second respective cumulative tensor offsets.

3. The method of claim 2, wherein the determining the first respective cumulative tensor offsets and the respective second tensor offsets comprises:
determining an N-th variable as a current variable and an N-th dimension as a current dimension; and
determining whether the current variable is smaller than a larger dimension size among a dimension size of the current dimension of the first tensor and a dimension size of the current dimension of the second tensor, and
wherein the N is a natural number less than or equal to M, a total number of dimensions of the first tensor and the second tensor, and greater than or equal to 1.

4. The method of claim 3, wherein the determining the first respective cumulative tensor offsets and the respective second tensor offsets further comprises:
in response to the N being greater than or equal to 1 and less than M, and the current variable being smaller than a larger dimension size among the dimension size of the current dimension of the first tensor and the dimension size of the current dimension of the second tensor, updating the N-th variable by adding 1 to the N-th variable, determining a cumulative offset of a (N+1)-th dimension of the first tensor as a first specific value, determining a cumulative offset of a (N+1)-th dimension of the second tensor as the first specific value, and determining a (N+1)-th variable as a first predetermined value; and
performing the determining of whether the current variable is smaller than a larger dimension size among the dimension size of the current dimension of the first tensor and the dimension size of the current dimension of the second tensor by updating the (N+1)-th variable to the current variable and updating the (N+1)-th dimension to the current dimension.

5. The method of claim 3, wherein the determining the first respective cumulative tensor offsets and the respective second tensor offsets comprises:
in response to the N being equal to M, and the current variable being smaller than a larger dimension size among the dimension size of the current dimension of the first tensor and the dimension size of the current dimension of the second tensor, updating the N-th variable by adding 1 to the N-th variable, determining the first offset based on the sum of the first respective cumulative tensor offsets, and determining the second offset based on the sum of the second respective cumulative tensor offsets.

6. The method of claim 3, wherein the determining the first respective cumulative tensor offsets first offset and the respective second tensor offsets further comprises:
in response to the N being greater than 1 and less than or equal to M, and the current variable being greater than or equal to a larger dimension size among the dimension size of the current dimension of the first tensor and the dimension size of the current dimension of the second tensor, updating a cumulative offset corresponding to a (N−1)-th dimension of the first tensor by adding an offset corresponding to the (N−1)-th dimension of the first tensor to the cumulative offset corresponding to the (N−1)-th dimension of the first tensor, and updating a cumulative offset corresponding to a (N−1)-th dimension of the second tensor by adding an offset corresponding to the (N−1)-th dimension of the second tensor to the cumulative offset corresponding to the (N−1)-th dimension of the second tensor; and
performing the determining of whether the current variable is smaller than a larger dimension size by updating the (N−1)-th variable to the current variable and updating the (N−1)-th dimension to the current dimension.

7. The method of claim 1, wherein the determining the respective first tensor offsets and the respective second tensor offsets further comprises:
in response to a value of an N-th dimension of the broadcasting type being a first value, determining an offset corresponding to the N-th dimension of the first tensor as an offset corresponding to the N-th dimension of the first shape, and determining an offset corresponding to the N-th dimension of the second tensor as an offset corresponding to the N-th dimension of the second shape;
in response to the value of the N-th dimension of the broadcasting type being a second value, determining the offset corresponding to the N-th dimension of the first tensor as a second specific value, and determining the offset corresponding to the N-th dimension of the second tensor as the offset corresponding to the N-th dimension of the second shape; and
in response to the value of the N-th dimension of the broadcasting type being a third value, determining the offset corresponding to the N-th dimension of the first tensor as the offset corresponding to the N-th dimension of the first shape, and determining the offset corresponding to the N-th dimension of the second tensor as the second specific value, and
wherein the N is a natural number less than or equal to M, a total number of dimensions of the first tensor and the second tensor, and greater than or equal to 1.

8. The method of claim 1, wherein the determining of the respective first shape offsets and the respective second shape offsets comprises:
determining a first offset of each dimension except a rightmost dimension of the first shape based on at least one next dimension, and determining a third offset of the rightmost dimension of the first shape as a third specific value; and
determining a second offset of each dimension except a rightmost dimension of the second shape based on the at least one next dimension, and determining a fourth offset of the rightmost dimension of the second shape as the third specific value.

9. The method of claim 1, wherein the determining of the broadcasting type comprises:
in response to the first shape and the second shape having a same dimension size in an N-th dimension, determining a dimension value of the N-th dimension of the broadcasting type as a first value;
in response to the first shape and the second shape having different dimension sizes in the N-th dimension and the first shape having 1 in the N-th dimension, determining the dimension value of the N-th dimension of the broadcasting type as a second value; and
in response to the first shape and the second shape having different dimension sizes in the N-th dimension and the second shape having 1 in the N-th dimension, determining the dimension value of the N-th dimension of the broadcasting type as a third value, and
wherein the N is a natural number less than or equal to M, a total number of dimensions of the first tensor and the second tensor, and greater than or equal to 1.

10. The method of claim 1, further comprising:
in response to the first shape of the first tensor and the second shape of the second tensor having a dimension size in at least two corresponding consecutive dimensions, determining the first shape and the second shape by merging the at least two consecutive dimensions.

11. A non-transitory, computer-readable storage medium storing instructions that, when executed by a processor, cause the processor to perform the method of claim 1.

12. A processor-implemented method, the method comprising:
based on a first shape of a first tensor and a second shape of a second tensor used in an operation with the first tensor, determining a broadcasting type related to an extension of the first shape and the second shape; and
performing an operation of the first tensor and the second tensor by executing a pre-generated program based on the broadcasting type,
wherein the performing of the operation of the first tensor and the second tensor by executing the pre-generated program comprises:
determining respective first shape offsets for each dimension of the first shape and respective second shape offsets for each dimension of the second shape;
determining respective first tensor offsets for each dimension of the first tensor and respective second tensor offsets for each dimension of the second tensor based on the broadcasting type, the respective first shape offsets, and the respective second shape offsets;
determining a first offset of a first element included in the first tensor and a second offset of a second element included in the second tensor based on the respective first tensor offsets and the respective second tensor offsets; and
performing the operation by obtaining the first element and the second element based on the first offset and the second offset.

13. An electronic device, comprising:
one or more processors configured to execute instructions; and
a memory storing the instructions, wherein execution of the instructions configures the processors to:
based on a first shape of a first tensor and a second shape of a second tensor used in an operation with the first tensor, determine a broadcasting type related to an extension of the first shape and the second shape;
determine respective first shape offsets for each dimension of the first shape and respective second shape offsets for each dimension of the second shape based on the broadcasting type;
determine respective first tensor offsets for each dimension of the first tensor and respective second tensor offsets for each dimension of the second tensor based on the broadcasting type, the respective first shape offsets, and the respective second shape offsets;
determine a first offset of a first element included in the first tensor and a second offset of a second element included in the second tensor based on the respective first tensor offsets and the respective second tensor offsets; and
perform the operation by obtaining the first element and the second element based on the first offset and the second offset.

14. The electronic device of claim 13, wherein the one or more processors are further configured to:
determine first respective cumulative tensor offsets for each dimension of the first tensor and second respective cumulative tensor offsets for each dimension of the second tensor based on the respective first tensor offsets and the respective second tensor offsets; and
determine the first offset and the second offset based on a sum of the first respective cumulative tensor offsets and a sum of the second respective cumulative tensor offsets.

15. The electronic device of claim 14, wherein the one or more processors are further configured to:
determine an N-th variable as a current variable and an N-th dimension as a current dimension; and
determine whether the current variable is smaller than a larger dimension size among a dimension size of the current dimension of the first tensor and a dimension size of the current dimension of the second tensor, and
wherein the N is a natural number less than or equal to M, a total number of dimensions of the first tensor and the second tensor, and greater than or equal to 1.

16. The electronic device of claim 15, wherein the one or more processors are further configured to:
in response to the N being greater than or equal to 1 and less than M, and the current variable being smaller than a larger dimension size among the dimension size of the current dimension of the first tensor and the dimension size of the current dimension of the second tensor, update the N-th variable by adding 1 to the N-th variable, determine a cumulative offset of a (N+1)-th dimension of the first tensor as a first specific value, determine a cumulative offset of a (N+1)-th dimension of the second tensor as a first specific value, and determine a (N+1)-th variable as a first predetermined value; and
perform the determination of whether the current variable is smaller than a larger dimension size among the dimension size of the current dimension of the first tensor and the dimension size of the current dimension of the second tensor by updating the (N+1)-th variable to the current variable and updating the (N+1)-th dimension to the current dimension.

17. The electronic device of claim 15, wherein the one or more processors are further configured to:
in response to the N being equal to M, and the current variable being smaller than a larger dimension size among the dimension size of the current dimension of the first tensor and the dimension size of the current dimension of the second tensor, update the N-th variable by adding 1 to the N-th variable, determine the first offset based on the sum of the first respective cumulative tensor offsets, and determine the second offset based on the sum of the second respective cumulative tensor offsets.

18. The electronic device of claim 15, wherein the one or more processors are further configured to:
in response to the N being greater than 1 and less than or equal to M, and the current variable being greater than or equal to a larger dimension size among the dimension size of the current dimension of the first tensor and the dimension size of the current dimension of the second tensor, update a cumulative offset corresponding to a (N−1)-th dimension of the first tensor by adding an offset corresponding to the (N−1)-th dimension of the first tensor to the cumulative offset corresponding to the (N−1)-th dimension of the first tensor, update a cumulative offset corresponding to a (N−1)-th dimension of the second tensor by adding an offset corresponding to the (N−1)-th dimension of the second tensor to the cumulative offset corresponding to the (N−1)-th dimension of the second tensor, and perform the determination of whether the current variable is smaller than a larger dimension size among the dimension size of the current dimension of the first tensor and the dimension size of the current dimension of the second tensor by updating the (N−1)-th variable to the current variable and updating the (N−1)-th dimension to the current dimension.

19. The electronic device of claim 13, wherein the one or more processors are further configured to:
in response to a value of an N-th dimension of the broadcasting type being a first value, determine an offset corresponding to the N-th dimension of the first tensor as an offset corresponding to the N-th dimension of the first shape, and determine an offset corresponding to the N-th dimension of the second tensor as an offset corresponding to the N-th dimension of the second shape;
in response to the value of the N-th dimension of the broadcasting type being a second value, determine the offset corresponding to the N-th dimension of the first tensor as a second specific value, and determine the offset corresponding to the N-th dimension of the second tensor as the offset corresponding to the N-th dimension of the second shape; and
in response to the value of the N-th dimension of the broadcasting type being a third value, determine the offset corresponding to the N-th dimension of the first tensor as the offset corresponding to the N-th dimension of the first shape, and determine the offset corresponding to the N-th dimension of the second tensor as the second specific value, and
wherein the N is a natural number less than or equal to M, a total number of dimensions of the first tensor and the second tensor, and greater than or equal to 1.

20. The electronic device of claim 13, wherein the one or more processors are further configured to:
determine respective first dimension values of each dimension except a rightmost dimension of a first offset of the first shape as a product of dimension sizes of next dimensions of a corresponding dimension of the first shape, and determine a third dimension value of the rightmost dimension of the offset of the first shape as a third specific value; and
determine respective second dimension values of each dimension except a rightmost dimension of a second offset of the second shape as a product of dimension sizes of next dimensions of a corresponding dimension of the second shape, and determine a fourth dimension value of the rightmost dimension of the offset of the second shape as the third specific value.
